(19) United States
(12) Patent Application Publication
(10) Pub. No.: US 2014/0207831 A1
(43) Pub. Date: Jul. 24, 2014

(54) DATA CREATING DEVICE AND METHOD

(71) Applicant: AZBIL CORPORATION, Tokyo (JP)

(72) Inventors: Hiroshi OHYAMA, Tokyo (JP); Naoyuki AKAI, Tokyo (JP)

(73) Assignee: AZBIL CORPORATION, Tokyo (JP)

(21) Appl. No.: 14/162,989

(22) Filed: Jan. 24, 2014

(30) Foreign Application Priority Data
Jan. 24, 2013 (JP) 2013-011104

(51) Int. Cl. G06F 17/30

(52) U.S. Cl. CPC G06F 17/30312
USPC 707/812

(57) ABSTRACT

A data creating device includes a composite data creating portion that creates a copy of data that is stored in a data storing portion and creates composite data by applying changed data that has been inputted through a data inputting portion, a comparing portion that compares the composite data created by the composite data creating portion and the data that is stored in the data storing portion to extract, from the composite data, parts that are different from the data, and a display controlling portion that displays, on a displaying portion, the data that is stored in the data storing portion along with the composite data, in a form wherein it is possible to identify the parts in the composite data that are different, extracted by the comparing portion, and parts that are same.

### CROSS REFERENCE TO RELATED APPLICATION

This application claims priority under 35 U.S.C. §119 to Japanese Patent Application No. 2013-011104, filed on Jan. 24, 2013, the entire content of which being hereby incorporated herein by reference.

### FIELD OF TECHNOLOGY

The present invention relates to a data creating device and method for changing setting data used in control systems, instrument controlling devices, and the like.

### BACKGROUND

Control systems are used in monitoring and control of various types of equipment ancillary to buildings, controlling plants, and the like, and instrument controlling devices are also used. See, for example, Japanese Unexamined Patent Application Publication No. 2012-014388. For example, in instrument controlling devices, signals are exchanged between field instruments, such as process instruments and various types of sensors, equipped in a work area, connected through a network such as a FieldBus, where, conventionally, mobile terminals would be used to connect directly to field instruments to set, from above, parameters for calibration, or to display diagnostic results relating to the proper operating state of a field instrument.

With such a control system and instrument controlling device, if, for example, there is a change in the configuration of that which is to be controlled, this produces engineering work in having to change the field instrument configuration that is set in the instrument controlling device. Such control can be applied to a large variety of instruments and, in the engineering work, the applicable data may be vast. Consequently, in the engineering work, work is performed to edit or changes data using tools (software) available on the market that have superior abilities for editing large amounts of data, where the new data that is produced is applied to controlling programs and field instrument configurations.

However, when applying changed data to the controlling programs and field instrument configurations as described above, if there are, for example, setting errors in the changed data, then there will be erroneous control or displays in the controlling programs and field device configurations to which it is applied. Because of this, prior to applying the changed data, the points that have been changed are checked. However, because there is an extremely large number of points, this checking requires a vast amount of time.

The present invention is to solve problems such as set forth above, and an aspect thereof is to enable easy checking of changed points in changed data that is to be applied to controlling programs in control systems and to field instrument configurations in instrument controlling devices.

### SUMMARY

A data creating device to the present invention includes: a data storing portion that stores data that is used by an applicable instrument that is connected through a network; a displaying portion that displays visibly data that is stored in the data storing portion; a data inputting portion that receives changed data that changes data that is stored in the data storing portion; a composite data creating portion that creates a copy of the data that is stored in the data storing portion and creates composite data by applying the changed data that has been inputted through the data inputting portion; a comparing portion that compares the composite data created by the composite data creating portion and the data that is stored in the data storing portion to extract from the composite data the parts that are different from the data; and a display controlling portion that displays, on the displaying portion, the data that is stored in the data storing portion along with the composite data, in a form wherein it is possible to identify the parts in the composite data that are different, extracted by the comparing portion, and the parts that are the same.

In this data creating device, the display controlling portion may display, on the display portion composite data wherein the parts that are the same and the parts that are different are given different display colors.

In this data creating device, a comparing portion may extract, as parts that are different, the parts that have been changed and the parts that are new in the composite data, and a display controlling portion may display, on the displaying portion, the composite data in a form wherein the parts that have been changed and the parts that are new in the composite data, extracted by the comparing portion, and the parts that are the same can each be identified. For example, the display controlling portion may display, on the displaying portion, composite data wherein parts that have been changed, parts that are new, and parts that are the same are each displayed in different colors.

The data creating device set forth above may include a data setting portion that receives an instruction for applying a change and applies, to the data that is stored in the data storing device, changed data that has been received from the data inputting portion.

Moreover a data creating method according to the present invention includes: a data storing step for storing data that is used by an applicable instrument that is connected through a network; a data inputting step for receiving changed data that changes data that was stored in the data storing step; a composite data creating step for creating a copy of the data that was stored in the data storing step and creating composite data by applying the changed data that has been inputted in the data inputting step; a comparing step for comparing the composite data created in the composite data creating step and the data that was stored in the data storing step to extract from the composite data the parts that are different from the data; and a display controlling step for displaying the data that was stored in the data storing step along with the composite data, in a form wherein it is possible to identify the parts in the composite data that are different, extracted in the comparing step, and the parts that are the same.

In this data creating method, composite data wherein the parts that are the same and the parts that are different are given different display colors may be displayed on the display portion in the display controlling portion.

In this data creating method, in the comparing step the parts that have been changed and the parts that are new in the composite data may be extracted as parts that are different, and in the display controlling step, the composite data may be displayed in a form wherein the parts that have been changed and the parts that are new in the composite data, extracted by the comparing portion, and the parts that are the same can each be identified. For example, in the display controlling step composite data may be displayed wherein parts that have been changed, parts that are new, and parts that are the same are each displayed in different colors.

The data creating method set forth above may include a data setting step for receiving an instruction for applying a change, and for applying, to the data that was stored in the data storing step, changed data that has been received in the data inputting step.

Given that which is explained above, the present invention provides a superior effect of enabling the changed points of changed data that is to be applied to a controlling program in a control system or to field instrument configuration of an instrument controlling device, to be checked more easily.

### BRIEF DESCRIPTIONS OF THE DRAWINGS

FIG. 1 is a structural diagram illustrating the structure of a data creating device 100 in an example according to the present invention.

FIG. 2 is a flowchart for explaining the operation (the data creating method) in the data creating device 100 in an example according to the present invention.

FIG. 3 is an explanatory diagram illustrating an example of a display on the displaying portion 102.

### DETAILED DESCRIPTION

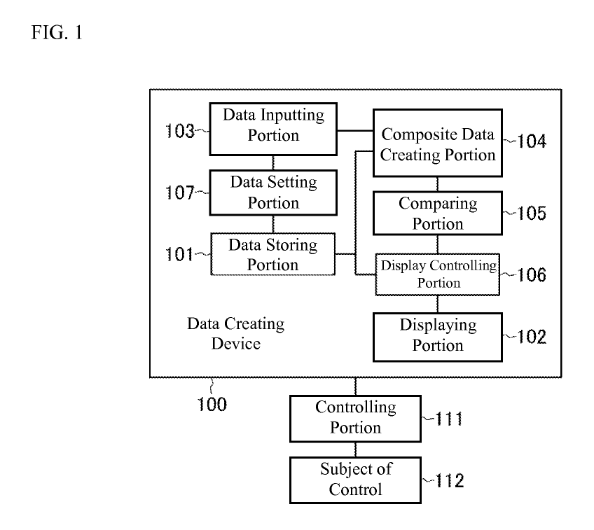

Forms for carrying out the present invention will be explained below in reference to the figures. FIG. 1 is a structural diagram illustrating the structure of a data creating device 100 in an example according to the present invention. This data creating device 100 includes: a data storing portion 101, a displaying portion 102, a data inputting portion 103, a composite data creating portion 104, a comparing portion 105, a display controlling portion 106, and a data setting portion 107. The controlling portion 111 controls a controlled process 112, for example, using data created by the data creating device 100, stored in the data storing portion 101.

The data storing portion 101 stores, for example, data that is used in the applicable instruments (controlling portion 111 and process 112), connected through a network, such as control data for controlling a process 112. Moreover, in a case wherein the applicable instrument is an instrument controlling device, data indicating the configuration of the instrument that is to be controlled, such as a field instrument, is stored. The data is, for example, setting information for the field device, such as a process device or a sensor of some type, as shown in Table 1, below.

TABLE 1

| | | Controller | IOM | Slot | Work | PV Upper | PV Lower | |
|---|---|---|---|---|---|---|---|---|
| Tab Name | Tab | No. | No. | No. | Units | Limit Range | Limit Range | . . . |
| FI_0001_A | AI | 11 | 1 | 1 | L/min | 50 | 0 | |
| FI_0002_A | AI | 11 | 1 | 2 | M1/sec | 200 | 0 | |
| FX_0001_A | AO | 11 | 2 | 1 | | 100 | 0 | |
| FX_0002_A | AO | 12 | 5 | 7 | | 100 | 0 | |

The displaying portion 102 displays, so as to be visible, data that is stored in the data storing portion 101.

The data inputting portion 103 receives changed data wherein the data that is stored in the data storing portion 101 has been changed through, for example, a user operation. The composite data creating portion 104 creates composite data wherein a copy of data that is stored in the data storing portion 101 is created and changed data that is inputted into the data inputting portion 103 is applied. For example, the composite data creating portion 104 is provided with a temporary storing portion, and the composite data that is created is stored in the temporary storing portion.

A comparing portion 105 compares the composite data that is created by the composite data creating portion 104 to the data that is stored in the data storing portion 101, to extract those places in the composite data that are different from the data. For example, the comparing portion 105 extracts, as parts that are different, those places within the composite data wherein data has been changed (modified) or that are parts that are new, which were not in the data.

The display controlling portion 106 displays, on the displaying portion 102, the data that is stored in the data storing portion 101, as well as the composite data in a state where it is possible to identify, in the composite data, the parts that are different, extracted by the comparing portion 105, and the parts that are the same. For example, the display controlling portion 106 displays, on the displaying portion 102 composite data wherein the parts that are the same and the parts that are different are given different display colors. Moreover, for example, the display controlling portion 106 displays, on the displaying portion 102, composite data wherein parts that have been changed, parts that are new, and parts that are the same are each displayed in different colors.

Additionally, the data setting portion 107 receives an instruction to apply a change, and the data inputting portion 103 stores, to the data storing portion 101, the changed data that has been received. Note that, as described above, the controlling portion 111 controls the process 112 that is connected, through the network, to the data that is stored in the data storing portion 101 of the data creating device 100.

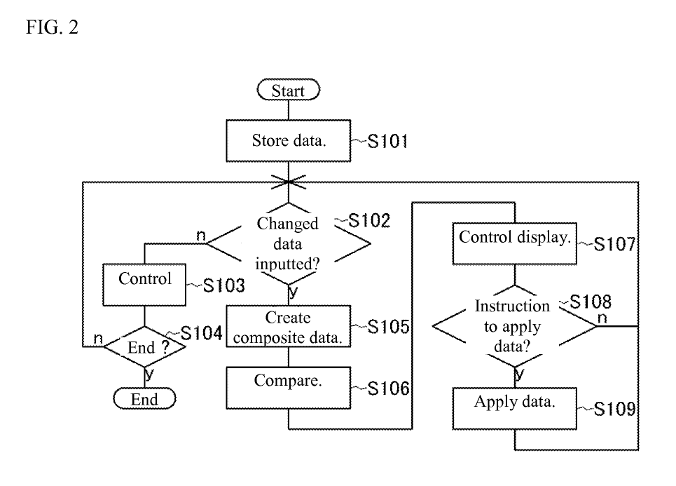

The operation of the data creating device in an example according to the present invention (a data creating method) will be explained using the flowchart in FIG. 2.

First, in Step S101, the data that is used in the applicable instrument (the controlling portion 111 and the process 112) that is connected through the network is stored in the data storing portion 101 (data storing step). For example, data that is inputted through the data inputting portion 103 through a user operation is stored in the data storing portion 101.

Following this, in Step S102, the input, by the data inputting portion 103, of changed data to change the data that is stored in the data storing portion 101 is detected (data inputting step). For example, if changed data is inputted through a user operation, this is detected in the data inputting portion 103.

If the data is control data, and there is no input of changed data (n in Step S102), then the controlling portion 111 is actuated when there is a user instruction, and data that is stored in the data storing portion 101 is sent to the controlling portion 111, to execute control of the process 112 that is connected through the network (Step S103). The controlling portion 111 continues control until the receipt of an instruction for terminating control (Step S104). This is continued until an instruction from a user.

When an input of changed data in the data inputting portion 103 is detected and received (y in Step S102), then, in Step S105, first the composite data creating portion 104 creates a copy of the data that is stored in the data storing portion 101, and then creates composite data to which the changed data that has been inputted is applied, and then, for example, stores, into a temporary storing portion, the composite data that has been created (composite data creating step).

Following this, in Step S106, the comparing portion 105 compares the composite data that has been created by the composite data creating portion 104 and the data that is stored in the data storing portion 101, to extract, from the data in the composite data, the parts that are different (comparing portion). Next, in Step S107, the display controlling portion 106 displays, on the displaying portion 102, the data that is stored in the data storing portion 101, along with displaying the composite data in a state wherein the parts that are different in the composite data, extracted by the comparing portion 105, and the composite data that is the same, in a state wherein they can be identified (display controlling step).

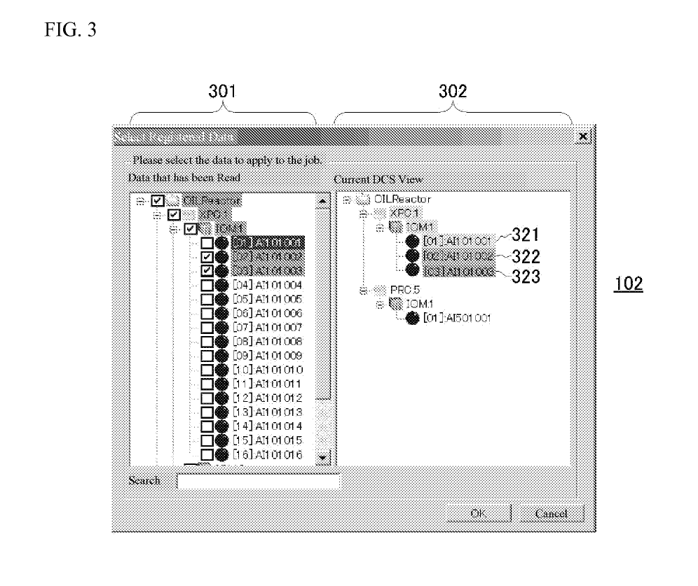

For example, as illustrated in FIG. 3, the data that is stored in the data storing portion 101 is displayed in a display region 301 on the displaying portion 102, and the composite data is displayed in a display region 302. Moreover, in the display region 302 for displaying the composite data, the items that are changed 322 and the items that are new 323 are each displayed in respective different display colors, in contrast to the items that are the same 321.

Thereafter, the data setting portion 107, when an instruction has been received to apply the changes (y in Step S108) applies, in Step S109, the changed data to the data that is stored in the data storing portion 101 (data setting step). On the other hand, if there is no input of the change applying instruction, for example, if there is an input of an instruction to not apply the change, or if there is no input of an instruction to apply the change before a specific time interval that has been set has elapsed, then processing returns to Step S102 without applying the changed data, and entry of new changed data is awaited.

Note that the data creating device 100 in the example set forth above is a computer device that is provided with, for example, a CPU (Central Processing Unit, or central computation processing device), a primary storage device, an external storage device, a network connecting device, and the like, where the various functions set forth above are enabled through the CPU operating following a program that is deployed into the main storage device. Moreover, the individual functions may be distributed over a plurality of computer devices.

As explained above, in the present invention, composite data is created wherein changed data, inputted into a copy of data, is applied, the composite data and the data are compared, the parts of the composite data that are different from the data are extracted, and the parts that are different and the parts that are the same are displayed so as to enable identification thereof, thus making it easier to check the changed points in the changed data that is to be applied to the controlling program in a control system or to the field instrument configuration in an instrument controlling device. Moreover, these checks are performed before applying the changes. The result is that even if there are tens of thousands of field devices that are subject to change, the differences can be checked easily, reducing the engineering errors and reducing the engineering cost.

Note that the present invention is not limited to the example set forth above, but rather, of course, many changes and combinations can be made by one of ordinary skill in the art, within the range of the technical concept of the present invention.

1. A data creating device comprising:
a data storing portion that stores data that is used by an applicable instrument that is connected through a network;
a displaying portion that displays visibly data that is stored in the data storing portion;
a data inputting portion that receives changed data that changes data that is stored in the data storing portion;
a composite data creating portion that creates a copy of the data that is stored in the data storing portion and creates composite data by applying the changed data that has been inputted through the data inputting portion;
a comparing portion that compares the composite data created by the composite data creating portion and the data that is stored in the data storing portion to extract from the composite data the parts that are different from the data; and
a display controlling portion that displays, on the displaying portion, the data that is stored in the data storing portion along with the composite data, in a form wherein it is possible to identify the parts in the composite data that are different, extracted by the comparing portion, and the parts that are the same.

2. The data creating device as set forth in claim 1, wherein:
the display controlling portion displays, on the displaying portion, composite data wherein the display colors are different for the parts that are different and the parts that are the same.

3. The data creating device as set forth in claim 1, wherein:
the comparing portion extracts, from the composite data, parts wherein the data is changed and parts that are new wherein there was no data, as parts that are different; and
the display controlling portion displays, on the displaying portion, the composite data in a form wherein the parts that have been changed and the parts that are new in the composite data, extracted by the comparing portion, and the parts that are the same can each be identified.

4. The data creating device as set forth in claim 3, wherein:
the display controlling portion displays the composite data wherein parts that have been changed, parts that are new, and parts that are the same are each displayed in different colors.

5. The data creating device as set forth in claim 1, comprising:
a data setting portion that receives an instruction for applying a change and applies, to the data that is stored in the data storing device, changed data that has been received from the data inputting portion.

6. A data creating method comprising:
a data storing step for storing data that is used by an applicable instrument that is connected through a network;
a data inputting step for receiving changed data that changes data that was stored in the data storing step;
a composite data creating step for creating a copy of the data that was stored in the data storing step and creating composite data by applying the changed data that has been inputted in the data inputting step;
a comparing step for comparing the composite data created in the composite data creating step and the data that was stored in the data storing step to extract from the composite data the parts that are different from the data; and
a display controlling step for displaying the data that was stored in the data storing step along with the composite data, in a form wherein it is possible to identify the parts in the composite data that are different, extracted in the comparing step, and the parts that are the same.

7. The data creating method as set forth in claim 6, wherein:
in the display controlling step, composite data wherein the display colors are different for the parts that are different and the parts that are the same are displayed.

8. The data creating method as set forth in claim 6, wherein:
in the comparing step, parts wherein the data is changed and parts that are new wherein there was no data, as parts that are different are extracted, from the composite data; and
in the display controlling step, the composite data is displayed in a form wherein the parts that have been changed and the parts that are new in the composite data, extracted by the comparing portion, and the parts that are the same can each be identified.

9. The data creating method as set forth in claim 8, wherein:
in the display controlling step, composite data is displayed wherein parts that have been changed, parts that are new, and parts that are the same are each displayed in different colors.

10. The data creating method as set forth in claim 6, comprising:
a data setting step for receiving an instruction for applying a change, and for applying, to the data that was stored in the data storing step, changed data that was received in the data inputting portion.
